(19) United States
(12) Patent Application Publication
(10) Pub. No.: US 2023/0125808 A1
(43) Pub. Date: Apr. 27, 2023

(54) INFORMATION PROCESSING DEVICE, CONTROL METHOD, AND STORAGE MEDIUM

(71) Applicant: NEC Corporation, Minato-ku, Tokyo (JP)

(72) Inventor: Nobutatsu NAKAMURA, Tokyo (JP)

(73) Assignee: NEC Corporation, Minato-ku, Tokyo (JP)

(21) Appl. No.: 17/909,478

(22) PCT Filed: Mar. 13, 2020
(86) PCT No.: PCT/JP2020/011180

§ 371 Date: Sep. 6, 2022

(51) Int. Cl. G06N 3/086; G06N 3/0455; G06N 3/047

(52) U.S. Cl. CPC G06N 3/086; G06N 3/0455; G06N 3/047

(57) ABSTRACT

An information processing device 1B mainly includes a machine learning means 15B, a sampling calculation means 16B, and a simulation calculation means 17B. The machine learning means 15B is configured to perform a machine learning of a model which represents the relation among observed data, an observation result, and a simulation parameter, the simulation parameter being required when performing a simulation for predicting the observation result based on observed data. The sampling calculation means 16B is configured to perform, based on a result of the machine learning, sampling of a simulation parameter to be used for machine learning. The simulation calculation means 17B is configured to perform a simulation using the sampled simulation parameter. The machine learning means 15B is configured to perform the machine learning again based on an error evaluation on a simulation result which is a result of the simulation.

### TECHNICAL FIELD

The present invention relates to a technical field of an information processing device, a control method, and a storage medium for performing processing related to simulation.

### BACKGROUND ART

There exists a technique to perform learning to obtain the optimal parameters of simulation. Further, Patent Literature 1 discloses a sampling device configured to perform quantum annealing by simulation in order to obtain data representing the weights and biases of each coupler and each node of a Boltzmann machine.

### CITATION LIST

### Patent Literature

Patent Literature 1: JP 2019-515397A

### SUMMARY

### Problem to be Solved

In the case of modeling the relation among observed data, observation results, and simulation parameters thereby to obtain one or more simulation parameters which match certain observed data, it is difficult to obtain sufficient number of observed data of a complex model for machine learning.

In view of the above-described issue, it is therefore an example object of the present disclosure to provide an information processing device, a control method, and a storage medium capable of suitably executing machine learning for obtaining simulation parameters.

### Means for Solving the Problem

In one mode of the information processing device, there is provided an information processing device including: a machine learning means configured to perform a machine learning of a model which represents the relation among observed data, an observation result, and a simulation parameter, the simulation parameter being required when performing a simulation for predicting the observation result based on observed data; a sampling calculation means configured to perform, based on a result of the machine learning, sampling of a simulation parameter to be used for machine learning; and a simulation calculation means configured to perform a simulation using the sampled simulation parameter, wherein the machine learning means is configured to perform the machine learning again based on an error evaluation on a simulation result which is a result of the simulation.

In one mode of the control method, there is provided a control method executed by a computer, the control method including: performing a machine learning of a model which represents the relation among observed data, an observation result, and a simulation parameter, the simulation parameter being required when performing a simulation for predicting the observation result based on observed data; performing, based on a result of the machine learning, sampling of a simulation parameter to be used for machine learning; performing a simulation using the sampled simulation parameter; and performing the machine learning again based on an error evaluation on a simulation result which is a result of the simulation.

In one mode of the storage medium, there is provided a storage medium storing a program executed by a computer, the program causing the computer to function as: a storage medium storing a program executed by a computer, the program causing the computer to function as: a machine learning means configured to perform a machine learning of a model which represents the relation among observed data, an observation result, and a simulation parameter, the simulation parameter being required when performing a simulation for predicting the observation result based on observed data; a sampling calculation means configured to perform, based on a result of the machine learning, sampling of a simulation parameter to be used for machine learning; and a simulation calculation means configured to perform a simulation using the sampled simulation parameter, wherein the machine learning means is configured to perform the machine learning again based on an error evaluation on a simulation result which is a result of the simulation.

### Effect

An example advantage according to the present invention is to suitably perform a machine learning for obtaining one or more simulation parameters.

### BRIEF DESCRIPTION OF THE DRAWINGS

FIG. 1 illustrates the configuration of a machine learning system according to the first example embodiment.

FIG. 2 illustrates the hardware configuration of the information processing information.

FIG. 3 illustrates the Ising equation representing the restricted Boltzmann machine.

FIG. 4 illustrates a schematic diagram of machine learning relating to simulation parameters.

FIG. 5 illustrates an outline of machine learning of a restricted Boltzmann machine which expresses the relation between visible variables and hidden variables as a neural network.

FIG. 6 is a functional block diagram of an information processing device and a storage device.

FIG. 7 is an example of a flowchart showing a processing procedure executed by the information processing device in the first example embodiment.

FIG. 8 illustrates the structure of the information processing device in a comparative example.

FIG. 9 illustrates an example of a block configuration diagram of an information processing device and a storage device in a second example embodiment using a multilayer neural network.

FIG. 10 is an example of a flowchart showing a processing procedure executed by the information processing device in the second example embodiment.

FIG. 11 is a block diagram of an information processing device in the third example embodiment.

FIG. 12 is an example of a flowchart showing a processing procedure executed by the information processing device in the third example embodiment.

### EXAMPLE EMBODIMENTS

Hereinafter, an example embodiment of an information processing device, a control method, and a storage medium will be described with reference to the drawings.

### First Example Embodiment

(1-1) System Configuration

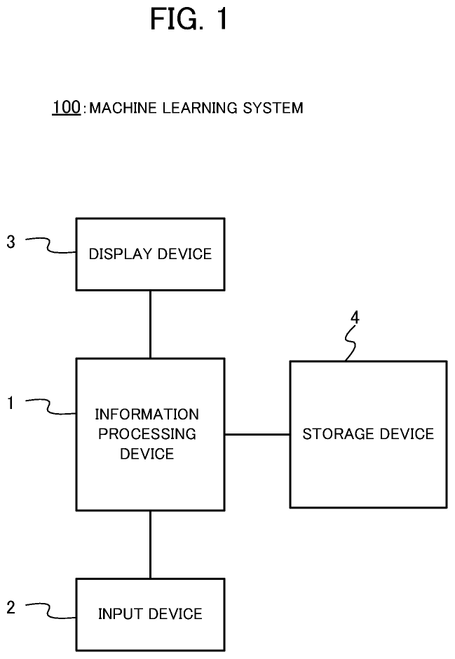

FIG. 1 shows the configuration of the machine learning system 100 according to the first example embodiment. The machine learning system 100 is a system for obtaining an optimal parameter of simulation, and mainly includes an information processing device 1, an input device 2, a display device 3, and a storage device 4.

The information processing device 1 calculates an optimal solution of one or more parameters (also referred to as “simulation parameters”) required when simulating by modeling a causal relation between observed data and observation results. The term “simulation” herein indicates a mathematical formula or a program capable of obtaining results consistent with or close to the target observation results to be predicted based on observed data. In this example embodiment, the information processing device 1 uses the method of a restricted Boltzmann machine, which is one of machine learning, and uses sampling according to the quantum annealing. Thus, the information processing device 1 obtains the optimal simulation parameters even with a small number of training data. The information processing device 1 performs data communication with the input device 2, the display device 3, and the storage device 4 through a communication network or by wireless or wired direct communication.

The input device 2 is an interface that accepts the input from the user, and examples of the input device 2 include a touch panel, a button, and a voice input device. The input device 2 supplies the input information generated based on the input from the user to the information processing device 1. The display device 3 is, for example, a display or a projector, and displays information based on the display information supplied from the information processing device 1.

The storage device 4 is a memory configured to store various kinds of information necessary for the information processing device 1 to execute processing. The storage device 4 may be an external storage device such as a hard disk connected to or built in to the information processing device 1, or may be a storage medium such as a flash memory. The storage device 4 may be one or more server devices configured to perform data communication with the information processing device 1. In this case, the storage device 4 may be configured by a plurality of server devices.

The configuration of the machine learning system 100 shown in FIG. 1 is an example, and various changes may be applied to the configuration. For example, the information processing device 1 may be configured by a plurality of devices. In this case, the plurality of devices functioning the information processing device 1 executes the processing assigned in advance, and transmits and receives information necessary for executing these processing among these devices. In this way, a series of processing performed by the information processing device 1 may be executed by a plurality of devices (i.e., by cloud devices).

(1-2) Hardware Configuration of Information Processing Information

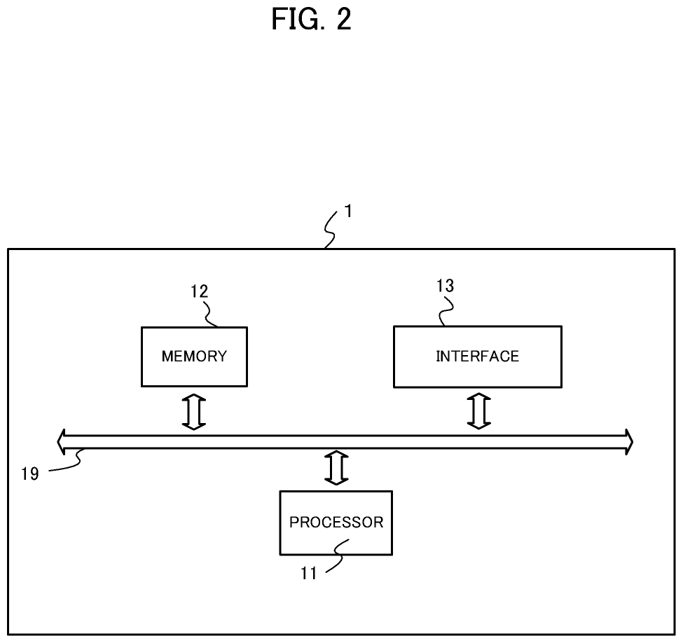

FIG. 2 shows the hardware configuration of the information processing device 1. The information processing device 1 includes a processor 11, a memory 12, and an interface 13 as hardware. The processor 11, the memory 12, and the interface 13 are connected via a data bus 19 to one another.

The processor 11 executes a predetermined process by executing a program stored in the memory 12. The processor 11 is one or more processors such as a CPU (Central Processing Unit), a GPU (Graphics Processing Unit), and a quantum processor.

The memory 12 is configured by various volatile memories and nonvolatile memories such as a RAM (Random Access Memory) and a ROM (Read Only Memory). In addition, a program for executing a process executed by the information processing device 1 is stored in the memory 12. The memory 12 is used as a work memory and temporarily stores information acquired from the storage device 4. The memory 12 may function as a storage device 4. Similarly, the storage device 4 may function as a memory 12 of the information processing device 1. The program executed by the information processing device 1 may be stored in a storage medium other than the memory 12.

The interface 13 is an interface for electrically connecting the information processing device 1 to other devices. For example, the interface 13 includes an interface for connecting the information processing device 1 to the input device 2, an interface for connecting the information processing device 1 to the display device 3, and an interface for connecting the information processing device 1 to the storage device 4. The interface for connecting the information processing device 1 to the other device is a wired or wireless communication interface such as a network adapter for transmitting and receiving data to and from the storage device 4 under the control of the processor 11. In other examples, the information processing device 1 and other devices may be connected by a cable or the like. In this case, the interface 13 includes an interface that conforms to a USB (Universal Serial Bus), a SATA (Serial AT Attachment), or the like for exchanging data with the storage device 4.

The hardware configuration of the information processing device 1 is not limited to the configuration shown in FIG. 2. For example, the information processing device 1 may include at least one of an input device 2 or a display device 3. Further, the information processing device 1 may be connected to or incorporate a sound output device such as a speaker.

(1-3) Overview Explanation

The information processing device 1 uses a restricted Boltzmann machine which expresses the relation between visible variables and hidden variables as a neural network. First, a supplementary explanation will be given of a restricted Boltzmann machine.

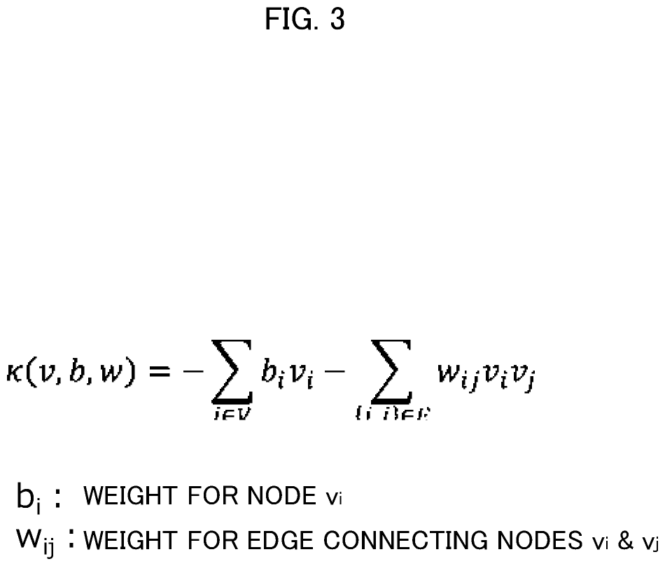

FIG. 3 shows the Ising equation representing the restricted Boltzmann machine. As shown in FIG. 3, the restricted Boltzmann machine is defined by the weights for nodes and edges of the network and is classified as an Ising model, and therefore it is a model to which a quantum annealing is applicable. In other words, when quantum annealing is applied to the restricted Boltzmann machine provisionally determined by learning, an energetically-stable sampling of the values of weights for nodes and edges can be achieved in its temporary state. By repeating learning using the sampled data, it is possible to obtain the dataset (i.e., learning model) of the weights corresponding to the maximum likelihood estimates, which is energetically stable.

Next, the derivation of the optimal simulation parameters using the restricted Boltzmann machine will be described. In the first example embodiment, the observed data and simulation parameters are used as visible variables, and the feature values that affect simulatable events with causality are used as hidden variables.

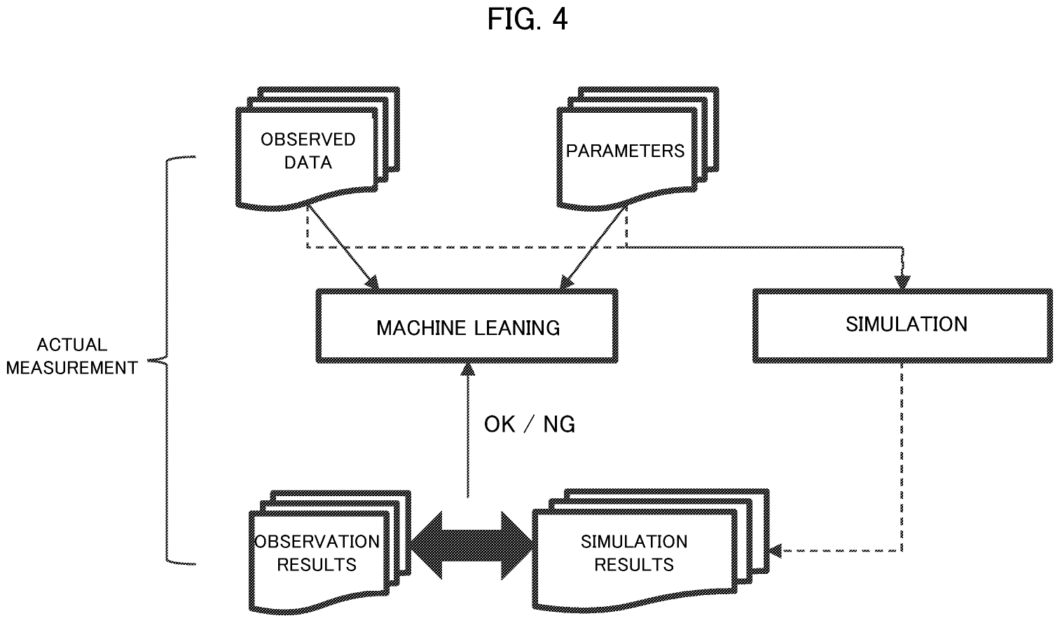

First, the information processing device 1 performs machine learning using: a combination of observed data obtained by actual measurement and its observation results; and a simulation parameters prepared provisionally. The “observation results” herein indicate the correct answer phenomenon or the like which should be predicted by simulation from the observed data. Then, the information processing device 1 performs machine learning of the binary classification in which a dataset is labeled as a positive example if the deference between simulation results obtained by using the temporary simulation parameter and the observation results is within an allowable error range and is otherwise labeled as a negative example. FIG. 4 is a schematic diagram of the machine learning described above. The term “parameters” in FIG. 4 indicates “simulation parameters”. As shown in FIG. 4, the information processing device 1 generates simulation results by simulation using observed data and simulation parameters. Then, the information processing device 1 compares the generated simulation results with the corresponding observation results, and performs machine learning of the binary classification on the assumption that the corresponding dataset is a positive example if these substantially coincide and that it is a negative example otherwise.

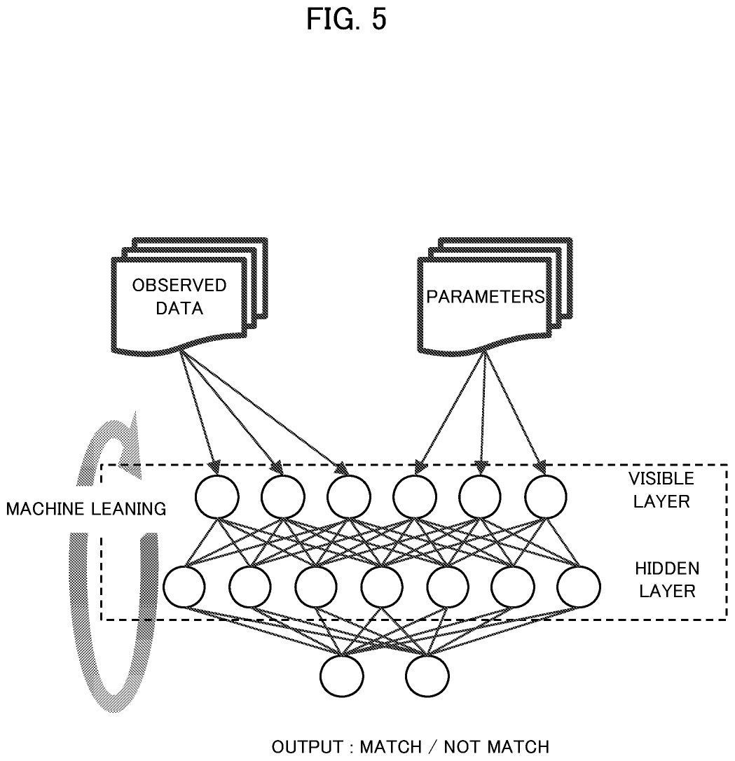

FIG. 5 shows an overview of machine learning of the restricted Boltzmann machine, which expresses the relation between visible variables and hidden variables as a neural network. As shown in FIG. 5, the restricted Boltzmann machine is a neural network represented by a two-layer network structure in which observed data is set to be the visible layer and features of the observed data are set to be the hidden layer. In Boltzmann machine, the sum of the weights for the nodes and the weights for the edges connecting nodes is defined as the energy of the network, and the combination of nodes and edges where the energy is minimized is the combination that occurs at the highest frequency, and therefore the modelization is to obtain the combination. Then, the information processing device 1 acquires the weight for each node and the weight for the edges included in the neural network shown in FIG. 5 by executing machine learning.

Next, the information processing device 1 performs sampling of visible variables by applying annealing to Boltzmann machine using the simulation parameters of the neural network as variables. Thus, the information processing device 1 can obtain one or more datasets of plausible simulation parameters corresponding to the hidden layer data.

Next, the information processing device 1 performs a simulation using each dataset of simulation parameters obtained by sampling, and labels each dataset as a positive example or a negative example based on the presence or absence of a difference between the simulation results and the observation results, and further performs machine learning as necessary. The information processing device 1 can determine a neural network with high accuracy by repeating the above sampling and machine learning. Thereafter, the information processing device 1 sets the observed data to be used for prediction in the visible layer, and uses, in the hidden layer, a neural network that is a sufficiently machine-learned machine learning model that is a Boltzmann machine, and performs sampling of simulation parameters. Thus, the information processing device 1 can suitably acquire one or more datasets of the optimal simulation parameters.

(1-4) Functional Block

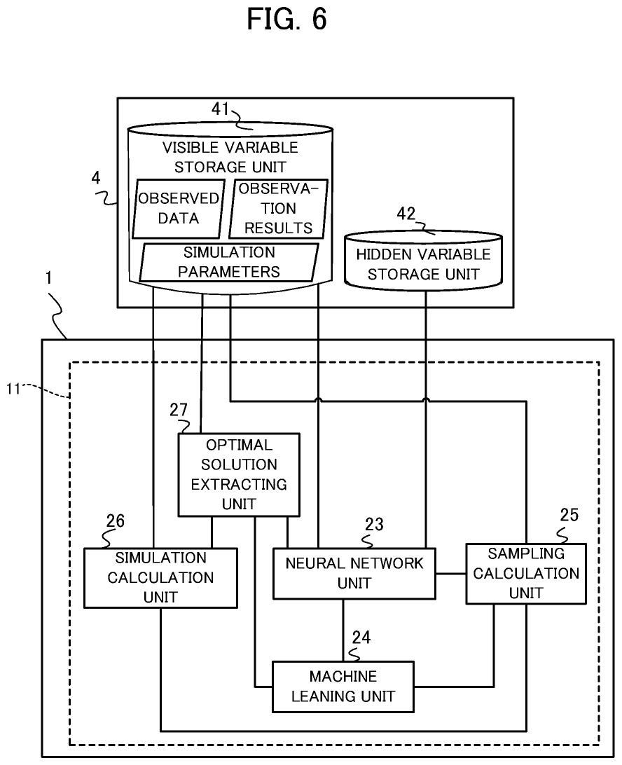

FIG. 6 is an example of a functional block of the information processing device 1 and the storage device 4. The processor 11 of the information processing device 1 functionally includes a neural network unit 23, a machine learning unit 24, a sampling calculation unit 25, a simulation calculation unit 26, and an optimal solution extracting unit 27. The storage device 4 functionally includes a visible variable storage unit 41 and a hidden variable storage unit 42. In FIG. 6, although blocks to perform transmission and reception of data or timing signals to or from each other are connected by solid line, the combination of blocks to perform transmission and reception of data or timing signals to or from each other is not limited to FIG. 6. The same applies to diagrams of other functional blocks to be described later.

The visible variable storage unit 41 stores information on the visible variables to be used in the restricted Boltzmann machine which expresses the relation among visible variables of the visible layer and hidden variables of the hidden layer as a neural network. Specifically, the visible variable storage unit 41 stores observed data that was observed, observation results indicating the correct answer to be predicted from the above-mentioned observed data, and temporary simulation parameters corresponding to the above-mentioned observed data. Here, the observed data and the observation results are data that was actually measured (observed), and the observed data is the data which has a causal relation with the corresponding observation results. For example, in the case of weather forecasting, the observed data is data indicating the weather data in a target area and the topography of the target area at a certain time point, and the observation results are weather data observed in the target area at a predetermined time after the certain time point. The causal relation described above is simulatable, and one or more variables representing the uncertainty in the simulation are expressed as simulation parameters. Therefore, the visible variable storage unit 41 stores, as visible variables, the simulation parameters the number of which corresponds to the number of the variables. The visible variable storage unit 41 stores, as training datasets for use in machine learning to be described later, sets of the observed data, the observation results, and one or more simulation parameters. Further, in addition to the training datasets, the visible variable storage unit 41 may further store the observed data to be used for prediction by the machine learning system 100.

The hidden variable storage unit 42 stores information on hidden variables used in the restricted Boltzmann machine which expresses the relation among visible variables of the visible layer and hidden variables of the hidden layer as a neural network. The hidden variables stored in the hidden variable storage unit 42 are state variables that cannot be directly measured, and are variables which indicate characteristics of the state and which is determined by calculation using the combination of visible variables. The number of hidden variables depends on the event being observed and is determined, for example, heuristically.

The neural network unit 23 configures a neural network based on the information that the visible variable storage unit 41 and the hidden variable storage unit 42 stores, respectively. This neural network includes parameters that are weights for each visible variable and each hidden variable and weights for the relation among them. Information on the parameters of the neural network (including the initial values and the values after learning) is stored in the hidden variable storage unit 42.

The machine learning unit 24 executes machine learning of the neural network that the neural network unit 23 configures based on the data stored in the visible variable storage unit 41 or the data sampled by the sampling calculation unit 25 to be described later. In this case, the machine learning unit 24 performs the learning of the neural network, which the neural network unit 23 configures, using the sets of the observed data, the observation results, and the simulation parameters stored in the visible variable storage unit 41 as the training datasets. In this case, the machine learning unit 24 learns the parameters of the neural network based on the error evaluation between the simulation results calculated from the observed data and the simulation parameters and the corresponding observation results. Then, the machine learning unit 24 performs machine learning of the binary classification using the dataset as a positive example if the error between the observation results and the simulation results is within the allowable error range, which is set in advance, and using the dataset as a negative example if the error is outside the allowable error range. The above simulation results may be calculated by the simulation calculation unit 36 or may be stored in advance in the visible variable storage unit 41 or the like. The machine learning unit 24 stores, in the hidden variable storage unit 42, the learned parameters including the weights for the nodes of the hidden layer and the weights for the edges.

In addition, when the sampling by the sampling calculation unit 25 to be described later is performed, the machine learning unit 24 further uses the sampled simulation parameters to train the neural network. In this case, the machine learning unit 24 performs error evaluation between the simulation results generated by the simulation calculation unit 36 based on the sampled simulation parameters and the observation results corresponding to the simulation parameters before the sampling. Then, based on the error evaluation, the machine learning unit 24 generates labels each indicating whether a sampled simulation parameter is a positive example or a negative example. Then, the machine learning unit 24 performs machine learning of the above-described binary classification using the generated labels, the sampled simulation parameters, and observed data and observation results corresponding to the simulation parameters before the sampling.

In the course of machine learning by the machine learning unit 24, the sampling calculation unit 25 uses the neural network, which the neural network unit 23 configures, as a Boltzmann machine and samples each variable of the visible layer and the hidden layer which are energetically stable. In general, in machine learning, a large number of datasets are usually prepared, and the training is repeatedly performed until the training result of the machine learning converges. In contrast, in the present example embodiment, the sampling by the sampling calculation unit 25 is calculated regardless of the state of convergence of the training. In this case, the sampling calculation unit 25 sets the simulation parameters as unknown variables and applies the numerical values already obtained through the machine learning to the parameters of the neural network (components such as weight parameters). Then, the sampling calculation unit 25 uses the neural network, which the neural network unit 23 configures, as a Boltzmann machine and repeatedly acquires the simulation parameters used for machine learning by performing quantum annealing or pseudo-annealing. This process is equivalent to performing an energetically-stable sampling with the maximum likelihood regarding the neural network. Thereafter, the machine learning unit 24 performs machine learning including the sampled datasets. It is noted that the observed data and observation results corresponding to the simulation parameters do not change before and after the sampling and therefore it is possible to perform the error evaluation regarding deviation from the simulation results by the simulation parameters obtained by sampling. The sampling calculation unit 25 stores the simulation parameters obtained by sampling in the visible variable storage unit 41.

The simulation calculation unit 26 generates simulation results derived from the observed data through the simulation based on the simulation parameters with respect to the observed data obtained from the visible variable storage unit 41.

Further, the machine learning unit 24 performs error evaluation regarding whether or not the error that is a comparison result between the simulation results by the simulation calculation unit 26 when the simulation parameters sampled by the sampling calculation unit 25 is used and the corresponding observation results is within the allowable error range. When the error is evaluated to be outside the allowable error range in the error evaluation, the machine learning unit 24 performs further machine learning. In this case, the machine learning by the machine learning unit 24, the sampling of simulation parameters by the sampling calculation unit 25, and simulation by the simulation calculation unit 26 are repeated again. On the other hand, when the error is evaluated to be within the allowable error range in the error evaluation, the machine learning unit 24 determines that the machine learning by the machine learning unit 24 is sufficiently performed, and notifies the optimal solution extracting unit 27 that the machine learning is completed.

When the optimal solution extracting unit 27 receives a notification of completion of machine learning from the machine learning unit 24, the optimal solution extracting unit 27 extracts the optimal simulation parameters using parameters obtained by machine learning by the machine learning unit 24. Specifically, the optimal solution extracting unit 27 sets the observed data to be used for prediction in the visible layer, and causes the neural network unit 23 to configure and set the neural network that is a sufficiently trained machine learning model in the hidden layer. Then, the optimal solution extracting unit 27 uses the neural network configured by the neural network unit 23 as a Boltzmann machine and performs sampling by performing quantum annealing or pseudo-annealing. Thereby, the optimal solution extracting unit 27 suitably extracts one or more datasets of simulation parameters that are the maximum likelihood estimates.

Each component of the neural network unit 23, the machine learning unit 24, the sampling calculation unit 25, the simulation calculation unit 26, and the optimal solution extracting unit 27 described in FIG. 6 can be realized, for example, by the processor 11 executing the program. More specifically, each component may be implemented by the processor 11 executing programs stored in the memory 12 or the storage device 4. In addition, the necessary program may be recorded in any non-volatile storage medium and installed as necessary to realize the respective components. Each of these components is not limited to being implemented by software using a program, and may be implemented by any combination selected from hardware, firmware, and software. Each of these components may also be implemented using user programmable integrated circuitry, such as, for example, FPGA (Field-Programmable Gate Array) or a microcomputer. In this case, the integrated circuit may be used to realize a program functioning each of the above-described components. Thus, each component may be implemented in hardware other than a processor. The above is the same in other example embodiments to be described later.

(1-5) Process Flow

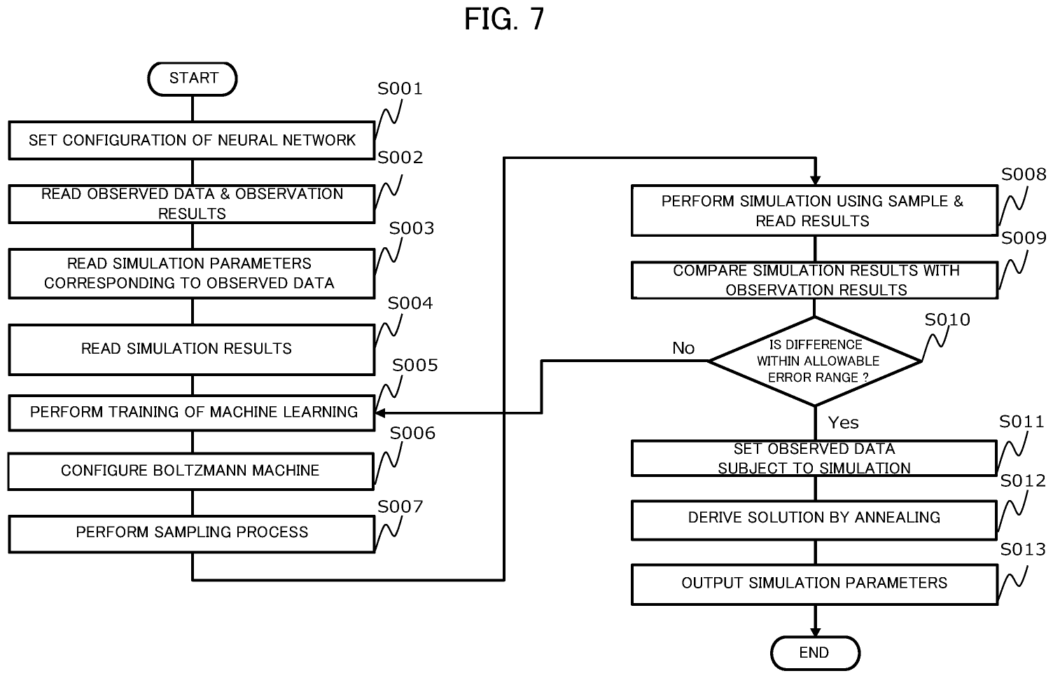

FIG. 7 is an example of a flowchart showing a processing procedure to be executed by the information processing device 1 in the first example embodiment. For example, the information processing device 1 executes the flowchart in FIG. 7 when detecting execution instructions based on an external input or the like supplied from the input device 2.

First, the neural network unit 23 performs the setting of the configuration of the neural network that is a model representing the correlation among the observed data, the observation results, and the simulated parameters (step S001). The neural network includes the same number of nodes as the number of visible variables and hidden variables indicative of hidden features, and the weights for the nodes and the weights for edges connecting the nodes become uncertain variables (i.e., parameters to be determined by learning). The parameters related to the structure of the neural network are stored, for example, in the hidden variable storage unit 42.

Next, the neural network unit 23 reads the observed data and the observation results from the visible variable storage unit 41 (step S002). Furthermore, the neural network unit 23 reads, from the visible variable storage unit 41, the temporary simulation parameters corresponding to the read observed data (step S003). Next, the simulation calculation unit 26 generates simulation results by executing a simulation using the observed data and the simulation parameters, and the neural network unit 23 further reads the simulation results (step S004). In this case, the simulation calculation unit 26 generates a plurality of simulation results using a plurality of simulation parameters for each set of observed data and observation results that the visible variable storage unit 41 stores as the training data. When plural sets of the observed data and the observation results are stored in the visible variable storage unit 41 as the training data, the simulation calculation unit 26 sequentially executes the same processing for each set of observed data and the observation results.

Next, the machine learning unit 24 performs the training of the machine learning (step S005). In this case, the machine learning unit 24 inputs observed data and simulation parameters to the neural network configured by the neural network unit 23. Then, if the observation results and the simulation results are matched or close within the preset allowable error range, the machine learning unit 24 performs the training using them as a positive example, and if the observation results and the simulation results are not close within the allowable error range, it performs the training using them as a negative example. Then, the machine learning unit 24 executes this training for plural sets of the examples obtained by changing the input of observed data and the simulation parameters. The machine learning unit 24 repeats this training by a preset training number of times or until the error of the self-validation becomes smaller than a preset threshold value.

Next, the sampling calculation unit 25 performs the configuration of the Boltzmann machine (step S006). In this case, the sampling calculation unit 25 sets the values of the weights for the nodes and edges of the neural network to the temporary values obtained by the learning at step S005, and sets the simulation parameters to undetermined states (i.e., variables). Then, the sampling calculation unit 25 uses the neural network as a Boltzmann machine and performs sampling of the simulation parameters by applying an annealing technique (step S007). Thus, the sampling calculation unit 25 obtains the numerical values of the simulation parameters set as undetermined states, wherein the state in which the Boltzmann machine has the lowest energy is the most likely plausible state. The sampling calculation unit 25 executes the process of obtaining the numerical values of the simulation parameters by a predetermined number of times, and performs sampling of the predetermined number of the simulation parameters according to the number of execution times of the process.

The simulation calculation unit 26 executes the simulation using the simulation parameters sampled by the sampling calculation unit 25 to generate the simulation results (step S008). Then, the machine learning unit 24 compares (i.e., perform an error evaluation) the generated simulation results with the corresponding observation results stored in the visible variable storage unit 41 (step S009). Then, when the difference between the simulation results and the observation results is outside the allowable error range set in advance (step S010; No), the machine learning unit 24 determines that the machine learning is incomplete (insufficient). In this case, the machine learning unit 24 performs machine learning using more training data at step S005. At this time, in order to shorten the processing time, the machine learning unit 24 may perform additional training on the basis of the learning model generated by the previous machine learning. In this case, in some embodiments, the machine learning unit 24 may set parameters such as the number of training times and the learning rate based on the user input by the input device 2 so as to set each appropriate weight for learning using the simulation parameters sampled at step S007 and for learning without using the sampled simulation parameters.

At step S010, when the difference between the simulation results and the observation results is within the allowable error range (step S010; Yes), the information processing device 1 determines that machine learning is performed with enough accuracy and machine learning is completed, and then proceeds to the next process. Next, the optimal solution extracting unit 27 acquires the observed data to be used for prediction, and sets Boltzmann machine so that the simulation parameters are set as undefined (variables) and the weights for the nodes and edges in the hidden layer are set to the values obtained by machine learning (step S011). The optimal solution extracting unit 27 may acquire the observed data to be used for prediction from the visible variable storage unit 41 or may acquire the observed data from an external device via the interface 13.

Then, the optimal solution extracting unit 27 executes annealing by a predetermined number of times or until a predetermined statistical value (e.g., a probability distribution of the obtained sampled data) is obtained to thereby derive an optimal solution of the simulation parameters (step S012). Then, the optimal solution extracting unit 27 outputs the simulation parameters that are the optimal solution from the visible variable storage unit 41 (step S013). In this case, for example, the optimal solution extracting unit 27 displays the simulation parameters on the display device 3.

According to the above-described processing, the information processing device 1 can determine the appropriate simulation parameters in a short time. Specifically, by repeating the cycle of the machine learning by the machine learning unit 24, sampling by the sampling calculation unit 25, and the simulation by the simulation calculation unit 26, the information processing device 1 can perform a machine learning with high accuracy even when only small amount of (or biased) observed data is prepared. It can also be expected that the execution of machine learning with high accuracy leads to reduction of the number of training times of machine learning and therefore the machine learning is completed in a shorter time than before.

(1-6) Effect

A supplementary description will be given of the effect according to the first example embodiment.

Generally, possible combinations of simulation parameters to be used in weather, wind tunnel, fluid, material, drug discovery, and the like are infinite, and therefore it is difficult to obtain the suitable simulation parameters. Besides, it is necessary to be familiar with the simulation model and have the expert knowledge. For example, in the simulation of the weather, parameter sets including some errors are set in advance and simulation results based on the parameter sets are obtained. Then, one or more experts carry out an ensemble forecast in which the simulation results are compared and/or combined with one another. According to the above approach, the prediction is within the range of obtained results, but it is not a sufficient accuracy in terms of the maximum likelihood estimation. The reason is that the optimal simulation parameters cannot be selected according to the given situation.

One approach to obtain the optimal simulation parameters in a given situation is to find such simulation parameters that the simulation results match the observation results in a past situation similar to the given situation. However, the number of samples in similar past situations may not be sufficient. If there is a sufficient number of samples, machine learning can be used to estimate simulation parameters that match the given situation, but if the number of samples is not sufficient, the machine learning model becomes inaccurate and the obtained simulation parameters become inaccurate.

In consideration of the above, in the first example embodiment, the information processing device 1 repeats the cycle of machine learning by the machine learning unit 24, sampling by the sampling calculation unit 25, and simulation by the simulation calculation unit 26 while appropriately increasing the training data. This makes it possible to perform a machine learning with high accuracy even when only few (or biased) observed data are available.

Further, since the information processing device 1 according to the first example embodiment executes the simulation after the selection of the simulation parameters by sampling and performs the re-learning on the basis of the error evaluation of the simulation result. Accordingly, it is possible to obtain the optimal simulation parameters. This effect will be further described with reference to a comparative example.

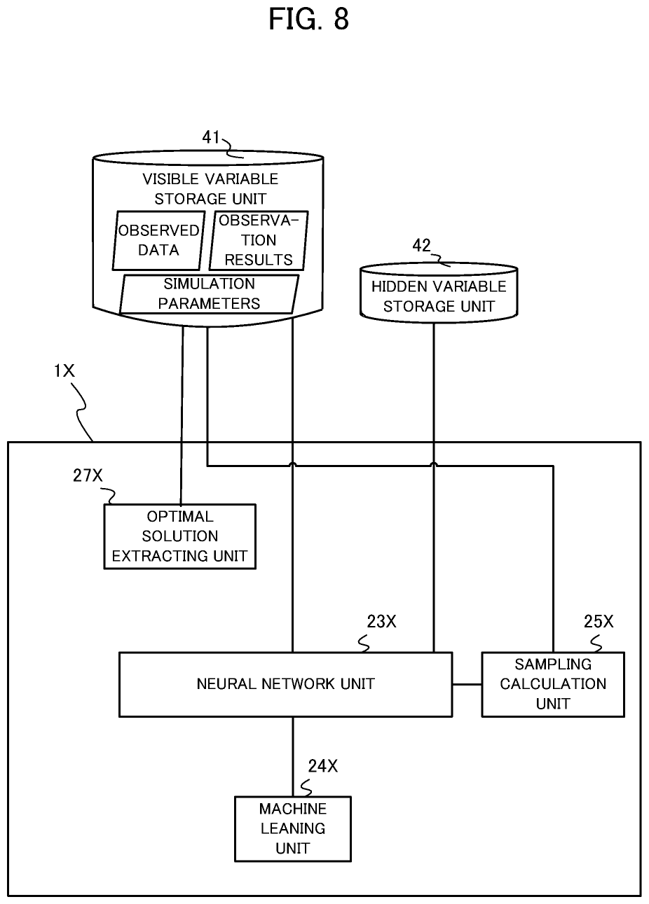

FIG. 8 shows the structure of the information processing device 1X according to a comparative example. The information processing device 1x does not include a simulation calculation unit 26 that the information processing device 1 includes.

In this case, the neural network unit 23X configures a neural network based on the variables stored by the visible variable storage unit 41 and the hidden variable storage unit 42. Then, the machine learning unit 24X prepares plural sets of observed data and simulation parameters, and performs machine learning using a difference between the results of the observed data and the simulation results for each of the sets, that is, performs machine learning using the sets with matched results as positive examples while using the sets with not matched results as negative examples. Then, the sampling calculation unit 25X performs the sampling computation regardless of whether or not this machine-learning converges. Namely, the sampling calculation unit 25X masks some elements while setting temporary numerical values to the components of the neural network. Then, the sampling calculation unit 25X uses the neural network as a Boltzmann machine, and then performs quantum annealing or pseudo-annealing, to obtain sampling datasets of non-masked elements of the neural network that are energetically stable with the maximum likelihood for the masked elements. Then, the machine learning unit 24X performs machine learning including the sampled datasets. Then, the optimal solution extracting unit 27X causes the neural network unit 23X to set such a neural network that the observed data to be used for prediction is set in the visible layer and the sufficiently-trained machine learning model is set in the hidden layer. Then, the optimal solution extracting unit 27X uses the neural network configured by the neural network unit 23X as a Boltzmann machine and performs sampling by performing quantum annealing or pseudo-annealing. Thereby, the optimal solution extracting unit 27X extracts the dataset of the simulation parameters that are the maximum likelihood estimates.

However, in the comparative example, since the observed data is not increased, it is difficult to obtain simulation parameters with high accuracy. In contrast, the information processing device 1 according to the first example embodiment executes the simulation after selecting the simulation parameters by sampling, and re-executes the machine learning based on the error evaluation of the simulation results. Accordingly, the information processing device 1 can suitably obtain appropriate simulation parameters.

(1-7) Modifications

A preferred modifications of the first example embodiment will be described. These modifications may also be applied to the second example embodiment to be described later.

(First Modification)

In the sampling process by the sampling calculation unit 25, the sampling calculation unit 25 may set variables including the observed data serving as visible variables. In this case, the machine learning unit 24 can additionally perform learning of various observed data obtained by sampling. In this case, since the observation results for the observed data obtained by sampling is unknown, the information processing device 1 receives the user input regarding labeling of the simulation results as a positive example or a negative example by an expert or the like through the input device 2.

(Second Modification)

When time series data generated during a long period of time is used, the number of input nodes in the network can become enormous. In that case, there is a method to learn for each of several subsets into which the network is divided. Therefore, the information processing device 1 may perform the cycle of sampling, machine learning, and simulation described in the first example embodiment in units of each divided network.

### Second Example Embodiment

In the second example embodiment, a multilayer neural network (i.e., deep neural network) with three or more layers is used to perform prediction and simulation for more complex events. In the first example in the case of using a multilayer neural network, sampling, machine learning, and simulation are repeated for one of the layers of the neural network. In the second example in the case of using a multilayer neural network, after the cycle of sampling, machine learning, and simulation is performed for one layer, the cycle of sampling, machine learning, and simulation is performed for another layer, and then the cycle of sampling, machine learning, and simulation is performed for the other layers in order.

(2-1) Functional Block

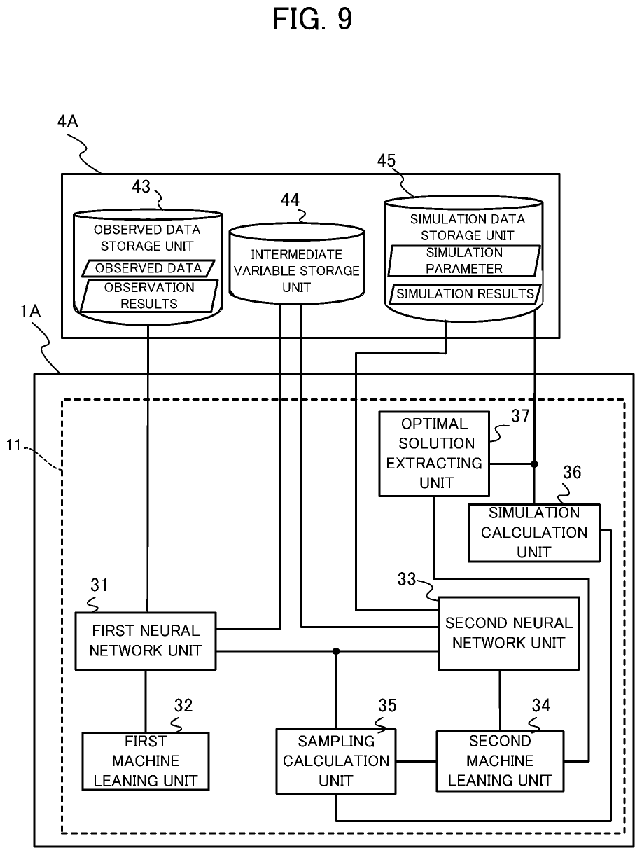

FIG. 9 illustrates an example of a block configuration diagram of an information processing device 1A and a storage device 4A according to a second example embodiment using a multilayer neural network. The information processing device 1A is capable of data communication with the input device 2, the display device 3, and the storage device 4A, and has the same hardware configuration as the information processing device 1 shown in FIG. 2. The processor 11 of the information processing device 1A includes a first neural network unit 31, a first machine learning unit 32, a second neural network unit 33, a second machine learning unit 34, a sampling calculation unit 35, a simulation calculation unit 36, and an optimal solution extracting unit 37. The storage device 4A includes an observed data storage unit 43, an intermediate variable storage unit 44, and a simulation data storage unit 45.

The observed data storage unit 43 stores sets, which serve as training data, of observed data and observation results. The observed data is data that is causally related to the observation results, and they correspond to the factors and results of a certain event and is stored in the observed data storage unit 43 by the number of variables of the observed data.

The intermediate variable storage unit 44 stores information on the variables of the one or more intermediate layers of the neural network to be described later. The data stored in the intermediate variable storage unit 44 is state variables that cannot be directly observed, but is variables that have an influence on the observation results and that indicate characteristics of the state that can be obtained by combinatorial calculation of the observed data. The number of variables of the intermediate layers depends on the event to be observed, but is heuristically determined.

The simulation data storage unit 45 stores the data including the simulation parameters and the simulation results to be used by the simulation calculation unit 36.

The first neural network unit 31 configures a neural network (also referred to as “first neural network”) including the weights for each data stored in the observed data storage unit 43 and the intermediate variable storage unit 44, and parameters relating to the weights for the relation among the data. The first neural network is a neural network representing the relation between the observed data stored in the observed data storage unit 43 and the observation results. The first neural network may be a deep neural network having three or more layers. The parameters of the first neural network are stored in memory 12 or in a storage device 4A.

The first machine learning unit 32 executes machine learning of the first neural network using data stored in the observed data storage unit 43. In this case, the first machine learning unit 32 repeatedly performs learning until the machine learning converges on the basis of the datasets stored in the observed data storage unit 43. Here, when the machine learning using the datasets stored in the observed data storage unit 43 does not converge, sampling of the observed data by the sampling calculation unit 35, which will be described later, is performed. In this case, the first machine learning unit 32 performs machine learning including the sampled datasets.

The second neural network unit 33 configures a neural network (also referred to as a “second neural network”) including parameters relating to the weights for the respective data stored in the observed data storage unit 43 and the intermediate variable storage unit 44 and the weights for the relation among the data. The second neural network is a neural network representing the relation between the simulation data including the simulation parameters stored in the simulation data storage unit 45 and the variables of the intermediate layers stored in the intermediate variable storage unit 44. The parameters of the second neural network are stored in memory 12 or in a storage device 4A.

The second machine learning unit 34 executes machine learning of the second neural network unit 33 using simulation data stored in the simulation data storage unit 45. In this case, the second machine learning unit 34 executes the machine learning of the second neural network that indicates the relation between the simulation results calculated by the simulation calculation unit 36 using the simulation parameters and the variables of the intermediate layers.

Further, in the same way as the machine learning unit 24 of the first example embodiment does, the second machine learning unit 34 performs error evaluation on the simulation parameters sampled by the sampling calculation unit 35. Then, based on the error evaluation, the second machine learning unit 34 performs generation of labels each indicating a positive example or a negative example, and machine learning of the second neural network unit 33 using the generated labels and the sampled simulation parameters. Further, the second machine learning unit 34 makes a determination of the completion of the machine learning of the second neural network unit 33 based on the error evaluation on the sampled simulation parameters.

The sampling calculation unit 35 performs sampling of the specified variables on the assumption that the first neural network and the second neural network are Boltzmann machines, respectively. In the case of the first neural network, the sampling calculation unit 35 uses the observed data as unknown variables and uses, as a Boltzmann machine, the first neural network in which other components of the neural network are set to the numerical values obtained by the previous machine learning, and performs quantum annealing or pseudo-annealing. Thereby, the sampling calculation unit 35 acquires sets of the observed data in accordance with the number of times of sampling. This is equivalent to an energetically stable sampling with a maximum likelihood regarding the first neural network. Thereafter, the first neural network with the maximum likelihood is obtained by the machine learning by the first machine learning unit 32 using the sampled datasets, and the variables of the intermediate layers are obtained.

In the case of the second neural network, the sampling calculation unit 35 uses the second neural network, which is machine-learned by the second machine learning unit 34, as a Boltzmann machine and samples the simulation parameters corresponding to the target observed data. Accordingly, the sampling calculation unit 35 acquires sets of simulation parameters corresponding to the number of times of sampling. This is equivalent to an energetically stable sampling with a maximum likelihood regarding the second neural network. Thereafter, the second neural network with the maximum likelihood is determined by the machine learning by the second machine learning unit 34 using the datasets of the sampled simulation parameters.

The simulation calculation unit 36 simulates the event relating to the observed data on a computer. The optimal solution extracting unit 37 extracts the optimal simulation parameters for the designated observation event. When the optimal solution extracting unit 37 receives a completion notification of the machine learning of the second neural network unit 33 from the second machine learning unit 34, it considers the learned second neural network as a restricted Boltzmann machine and extracts the maximum likelihood estimates of the simulation parameters.

(2-2) Processing Flow

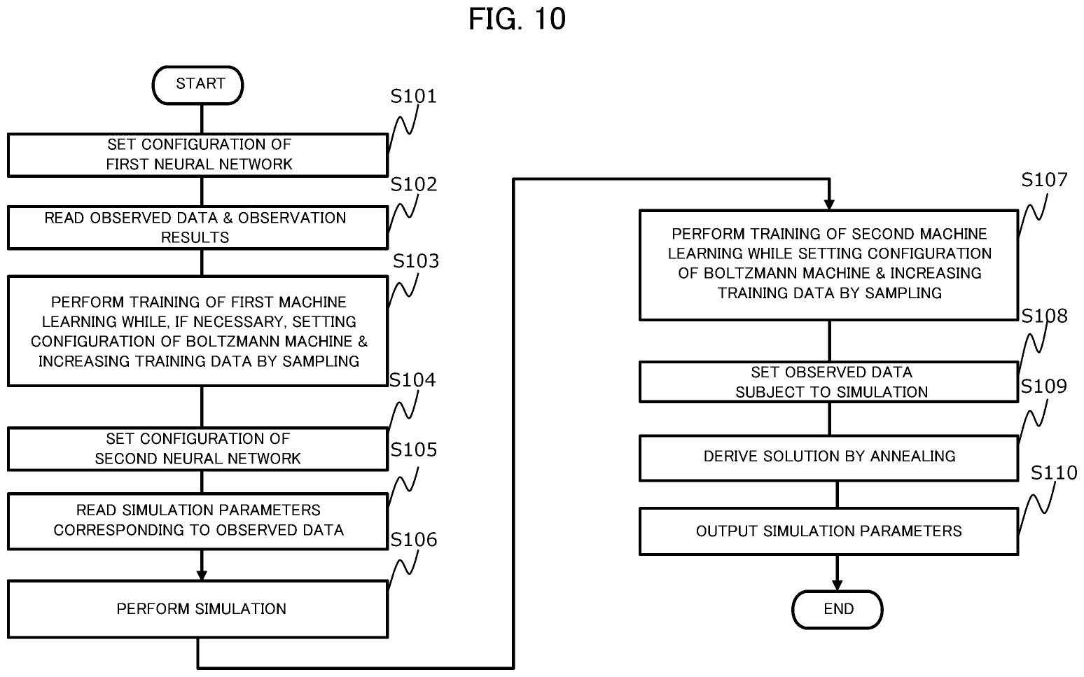

FIG. 10 is an example of a flowchart illustrating a processing procedure performed by the information processing device 1A in the second example embodiment. For example, the information processing device 1A executes the flowchart shown in FIG. 10 if it detects predetermined execution instructions based on an external input or the like supplied from the input device 2.

First, the first neural network unit 31 performs setting of the configuration of the first neural network that is a model representing the correlation between the observed data and the observation results (step S101). Next, the first neural network unit 31 reads the observed data and the observation results stored in the observed data storage unit 43 (step S102). Then, the first machine learning unit 32 executes the machine learning (also referred to as “first machine learning”) of the first neural network (step S103). In this case, for example, the first machine learning unit 32 repeatedly performs the first machine learning by a preset number of times, or, until an error based on self-validation or cross-validation is equal to or less than a predetermined threshold value. At this time, when the amount of the training data is insufficient, the sampling calculation unit 35 sets the first neural network as a Boltzmann machine and increases the amount of the training data by sampling. Thus, the first machine learning unit 32 suitably executes the first machine learning with high accuracy.

Next, the second neural network unit 33 sets the structure of the second neural network (step S104). The second neural network is a neural network which represents a relative relation among simulation parameters, simulation results, and the variables of the intermediate layers which correspond to the output from the first neural network and which are stored in the intermediate variable storage unit 44. Next, the simulation calculation unit 36 reads the simulation parameters corresponding to the observed data (step S105). Then, the simulation calculation unit 36 executes the calculation of the simulation corresponding to the observed data (step S106). The simulation calculation unit 36 stores the obtained simulation results in the simulation data storage unit 45.

Next, the second machine learning unit 34 executes machine learning (also referred to as “second machine learning”) of the second neural network (step S107). In this case, for example, the second machine learning unit 34 repeatedly performs machine learning by a preset number of times, or, until an error based on self-validation or cross-validation is equal to or less than a predetermined threshold value. At this time, when the amount of the training data is insufficient, the sampling calculation unit 35 sets the second neural network as a Boltzmann machine and increases the training data by sampling. Accordingly, the second machine learning unit 34 suitably executes machine learning with high accuracy. Specifically, the second machine learning unit 34 performs error evaluation on the simulation parameters sampled by the sampling calculation unit 35. Then, based on the error evaluation, the second machine learning unit 34 performs the generation of labels each indicating a positive example or a negative example, and machine learning of the second neural network unit 33 using the labels and the sampled simulation parameters. Further, the second machine learning unit 34 makes a determination of the completion of the machine learning of the second neural network unit 33 based on the error evaluation on the sampled simulation parameters.

Next, the optimal solution extracting unit 37 acquires the observed data to be used for prediction, and sets the simulation parameters as undefined (i.e., variables), and sets the numerical value obtained by machine-learning at step S107 to the Boltzmann machine (step S108). The optimal solution extracting unit 37 may acquire the observed data to be used for prediction from the observed data storage unit 43 or may acquire the observed data from an external device via the interface 13. Then, the optimal solution extracting unit 37 executes annealing by a predetermined number of times or until a predetermined statistical value (e.g., a probability distribution of the obtained sampling) is obtained, and extracts an optimal solution of the simulation parameters (step S109). Then, the optimal solution extracting unit 37 outputs the simulation parameters that are the optimal solution from the simulation data storage unit 45 (step S110). In this case, for example, the optimal solution extracting unit 37 displays the simulation parameters on the display device 3.

(2-3) Modifications

(Modification 2-1)

The information processing device 1A may use a neural network categorized as an auto-encoder configured to determine the variables of the intermediate layers instead of using a neural network categorized as a Boltzmann machine in the machine learning of the first neural network provided in the former part. However, in the neural network categorized as an auto-encoder, since sampling cannot be performed, the information processing device 1A does not increase the amount of the training data of the first neural network by sampling.

(Modification 2-2)

The first neural network may be a multilayer network. In that case, even the intermediate layers may be multilayers.

(Modification 2-3)

In the process for obtaining the simulation parameters based on the latter part of the second neural network, the optimal solution extracting unit 37 obtains the optimal simulation parameters by the method of combinatorial optimization based on quantum annealing/simulation annealing. Alternatively, the optimal solution extracting unit 37 may determine the optimal simulation parameters using a scheme that solves the optimal solution such as tabu search or genetic algorithm.

### Third Example Embodiment

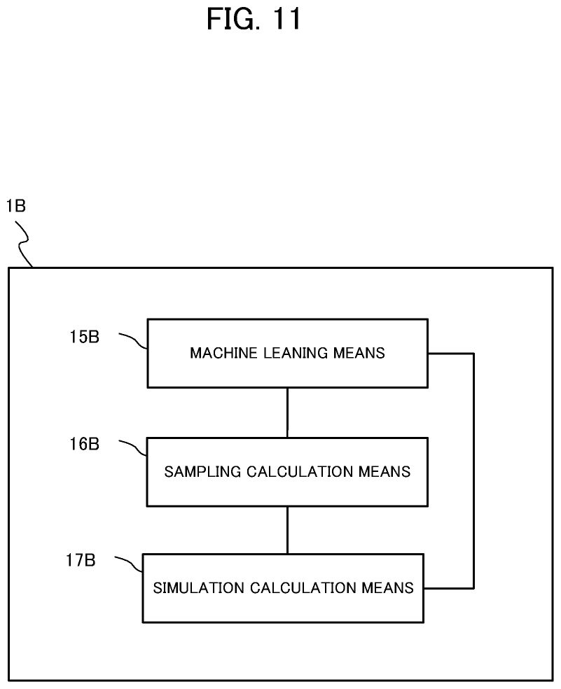

FIG. 11 is a block diagram of an information processing device 1B according to a third example embodiment. The information processing device 1B mainly includes a machine learning means 15B, a sampling calculation means 16B, and a simulation calculation means 17B. The information processing device 1B may be configured by a plurality of devices.

The machine learning means 15B is configured to perform a machine learning of a model which represents a relation among observed data, an observation result, and a simulation parameter, the simulation parameter being required when performing a simulation for predicting the observation result based on observed data. Examples of the machine learning unit 15B include the machine learning unit 24 in the first example embodiment or the second machine learning unit 34 in the second example embodiment. Examples of the above-mentioned model include a restricted Boltzmann machine in the first example embodiment or a multilayer neural network in the second example embodiment.

The sampling calculation means 16B is configured to perform, based on a result of the machine learning, sampling of a simulation parameter to be used for machine learning. Examples of the sampling calculation unit 16B include the sampling calculation unit 25 in the first example embodiment and the sampling calculation unit 35 in the second example embodiment.

The simulation calculation means 17B is configured to perform a simulation using the sampled simulation parameter. Examples of the simulation calculation unit 17B include the simulation calculation unit 26 in the first example embodiment or the simulation calculation unit 36 in the second example embodiment.

Then, the machine learning means 15B is configured to perform the machine learning again based on an error evaluation on a simulation result which is a result of the simulation. In this case, in the first example, the machine learning means 15B is configured to make a determination (i.e., completion determination) of whether or not to continue the machine learning based on the error evaluation. In the second example, the machine learning means 15B is configured to generate a label indicating whether the sampled simulation parameter is a positive example or a negative example based on the error evaluation and re-execute the machine learning based on the simulation parameter and the label.

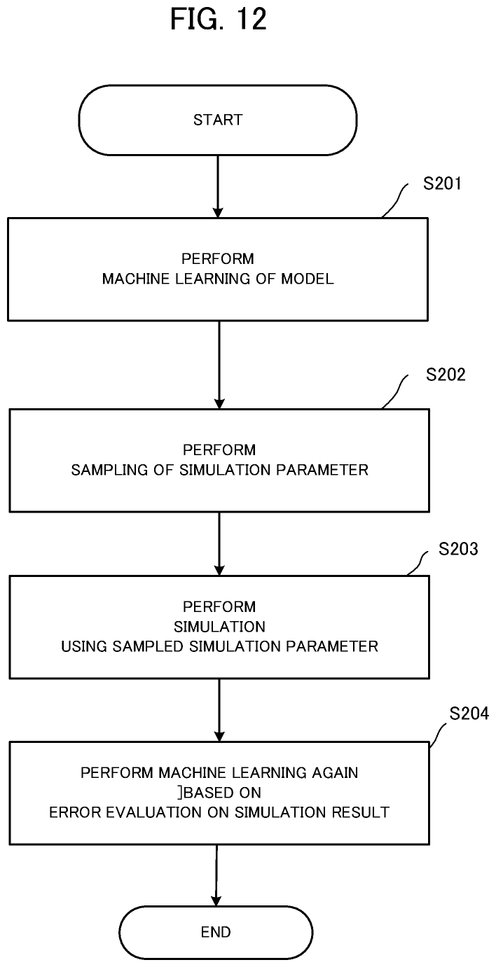

FIG. 12 is an example of a flowchart illustrating a processing procedure of the information processing device 1B according to the third example embodiment. The machine learning means 15B performs machine learning of a model which represents the relation among observed data, an observation result, and a simulation parameter (step S201). The sampling calculation means 16B performs, based on a result of the machine learning performed at step S201, sampling of a simulation parameter to be used for machine learning (step S202). The simulation calculation means 17B performs a simulation using the sampled simulation parameter (step S203). The machine learning means 15B performs the machine learning again based on an error evaluation on a simulation result which is a result of the simulation (step S204). To perform the machine learning again, the processes at step S201 to step S203 are executed again.

The information processing device 1B according to the third example embodiment can suitably perform the machine learning required to obtain the simulation parameters.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

[Supplementary Note 1]

An information processing device comprising:

a machine learning means configured to perform a machine learning of a model which represents the relation among observed data, an observation result, and a simulation parameter,
the simulation parameter being required when performing a simulation for predicting the observation result based on observed data;

a sampling calculation means configured to perform, based on a result of the machine learning, sampling of a simulation parameter to be used for machine learning; and

a simulation calculation means configured to perform a simulation using the sampled simulation parameter,

wherein the machine learning means is configured to perform the machine learning again based on an error evaluation on a simulation result which is a result of the simulation.

[Supplementary Note 2]

The information processing device according to Supplementary Note 1, further comprising

an optimal solution extracting means configured,
after a completion of the machine learning by the machine learning means,
to extract a maximum likelihood estimate of the simulation parameter by sampling on an assumption that the simulation parameter is regarded as a variable in the model.

[Supplementary Note 3]

The information processing device according to Supplementary Note 1 or 2,

wherein the model is a restricted Boltzmann machine.

[Supplementary Note 4]

The information processing device according to Supplementary Note 1 or 2,

wherein the model is a neural network including three or more layers.

[Supplementary Note 5]

The information processing device according to Supplementary Note 4,

wherein the model includes a first neural network configured in a former part of the model and a second neural network configured in a latter part of the model,

wherein the machine learning means is configured to
perform machine learning of the first neural network based on the observed data and the observation result and
perform a machine learning of the second neural network based on the output from the first neural network and the simulation parameter,

wherein the sampling calculation means is configured to perform,
based on a result of the machine learning of the second neural network,
the sampling of the simulation parameter to be used in the machine learning of the second neural network, and

wherein the machine learning means is configured to perform the machine learning of the second neural network again based on error evaluation on the simulation result obtained by using the sampled simulation parameter.

[Supplementary Note 6]

The information processing device according to Supplementary Note 5,

wherein the first neural network is a network categorized as an auto-encoder.

[Supplementary Note 7]

The information processing device according to Supplementary Note 5,

wherein the first neural network is a deep neural network.

[Supplementary Note 8]

The information processing device according to any one of Supplementary Notes 5 to 7, further comprising

an optimal solution extracting means configured,
after a completion of the machine learning by the machine learning means,
to extract a maximum likelihood estimate of the simulation parameter by sampling on an assumption that the simulation parameter is regarded as a variable in the second neural network.

[Supplementary Note 9]

The information processing device according to any one of Supplementary Notes 5 to 7, further comprising

an optimal solution extracting means configured,
after a completion of the machine learning by the machine learning means,
to extract an estimate of the simulation parameter by applying a tabu search or a genetic algorithm on an assumption that the simulation parameter is regarded as a variable in the second neural network.

[Supplementary Note 10]

The information processing device according to any one of Supplementary Notes 1 to 9,

wherein the machine learning means is configured to determine that the machine learning is completed when an error indicated by the error evaluation is equal to or less than a threshold value.

[Supplementary Note 11]

The information processing device according to any one of Supplementary Notes 1 to 10,

wherein the machine learning is a machine learning of binary classification based on a label of an inputted simulation parameter,
the label indicating either a positive example or a negative example, and wherein the machine learning means is configured
to generate the label based on the error estimation and thereby
to perform the machine learning again based on the sampled simulation parameter.

[Supplementary Note 12]

A control method executed by a computer, the control method comprising:

performing a machine learning of a model which represents the relation among observed data, an observation result, and a simulation parameter,
the simulation parameter being required when performing a simulation for predicting the observation result based on observed data;

performing, based on a result of the machine learning, sampling of a simulation parameter to be used for machine learning;

performing a simulation using the sampled simulation parameter; and

performing the machine learning again based on an error evaluation on a simulation result which is a result of the simulation.

[Supplementary Note 13]

A storage medium storing a program executed by a computer, the program causing the computer to function as:

a machine learning means configured to perform a machine learning of a model which represents the relation among observed data, an observation result, and a simulation parameter,
the simulation parameter being required when performing a simulation for predicting the observation result based on observed data;

a sampling calculation means configured to perform, based on a result of the machine learning, sampling of a simulation parameter to be used for machine learning; and

a simulation calculation means configured to perform a simulation using the sampled simulation parameter,

wherein the machine learning means is configured to perform the machine learning again based on an error evaluation on a simulation result which is a result of the simulation.

[Supplementary Note 14]

An information processing system comprising:

a machine learning means configured to perform a machine learning of a model which represents the relation among observed data, an observation result, and a simulation parameter,
the simulation parameter being required when performing a simulation for predicting the observation result based on observed data;

a sampling calculation means configured to perform, based on a result of the machine learning, sampling of a simulation parameter to be used for machine learning; and

a simulation calculation means configured to perform a simulation using the sampled simulation parameter,

wherein the machine learning means is configured to perform the machine learning again based on an error evaluation on a simulation result which is a result of the simulation.

[Supplementary Note 15]

The information processing system according to Supplementary Note 14, further comprising

an optimal solution extracting means configured,
after a completion of the machine learning by the machine learning means,
to extract a maximum likelihood estimate of the simulation parameter by sampling on an assumption that the simulation parameter is regarded as a variable in the model.

[Supplementary Note 16]

The information processing system according to Supplementary Note 14 or 15,

wherein the model is a restricted Boltzmann machine.

[Supplementary Note 17]

The information processing device according to Supplementary Note 14 or 15,

wherein the model is a neural network including three or more layers.

[Supplementary Note 18]

The information processing device according to Supplementary Note 17,

wherein the model includes a first neural network configured in a former part of the model and a second neural network configured in a latter part of the model,

wherein the machine learning means is configured to
perform machine learning of the first neural network based on the observed data and the observation result and
perform a machine learning of the second neural network based on the output from the first neural network and the simulation parameter,

wherein the sampling calculation means is configured to perform,
based on a result of the machine learning of the second neural network,
the sampling of the simulation parameter to be used in the machine learning of the second neural network, and

wherein the machine learning means is configured to perform the machine learning of the second neural network again based on error evaluation on the simulation result obtained by using the sampled simulation parameter.

[Supplementary Note 19]

The information processing device according to Supplementary Note 18,

wherein the first neural network is a network categorized as an auto-encoder.

[Supplementary Note 20]

The information processing device according to Supplementary Note 18,

wherein the first neural network is a deep neural network.

[Supplementary Note 21]

The information processing device according to any one of Supplementary Notes 18 to 20, further comprising

an optimal solution extracting means configured,
after a completion of the machine learning by the machine learning means,
to extract a maximum likelihood estimate of the simulation parameter by sampling on an assumption that the simulation parameter is regarded as a variable in the second neural network.

[Supplementary Note 22]

The information processing device according to any one of Supplementary Notes 18 to 20, further comprising

an optimal solution extracting means configured,
after a completion of the machine learning by the machine learning means,
to extract an estimate of the simulation parameter by applying a tabu search or a genetic algorithm on an assumption that the simulation parameter is regarded as a variable in the second neural network.

[Supplementary Note 23]

The information processing device according to any one of Supplementary Notes 14 to 22,

wherein the machine learning means is configured to determine that the machine learning is completed when an error indicated by the error evaluation is equal to or less than a threshold value.

[Supplementary Note 24]

The information processing device according to any one of Supplementary Notes 14 to 23,

wherein the machine learning is a machine learning of binary classification based on a label of an inputted simulation parameter,
the label indicating either a positive example or a negative example, and wherein the machine learning means is configured
to generate the label based on the error estimation and thereby
to perform the machine learning again based on the sampled simulation parameter.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### INDUSTRIAL APPLICABILITY

The present invention is suitably used for high-speed calculation of predictions with high accuracy in simulations in weather (including weather predictions targeting ocean, disaster prevention, etc.,), wind tunnels, fluids (including air resistance predictions conducted by car manufacturers), materials, and drug discoveries.

### DESCRIPTION OF REFERENCE NUMERALS

1, 1A, 1B Information processing device
2 Input device
3 Display device
4 Storage device
15B Machine learning means
16B Sampling calculation means
17B Simulation calculation means
100 Machine learning system

What is claimed is:

1. An information processing device comprising:
at least one memory configured to store instructions; and
at least one processor configured to execute the instructions to
perform a machine learning of a model which represents the relation among observed data, an observation result, and a simulation parameter,
the simulation parameter being required when performing a simulation for predicting the observation result based on observed data;
perform, based on a result of the machine learning, sampling of a simulation parameter to be used for machine learning; and
perform a simulation using the sampled simulation parameter,
wherein the at least one processor is configured to execute the instructions to perform the machine learning again based on an error evaluation on a simulation result which is a result of the simulation.

2. The information processing device according to claim 1,
wherein the at least one processor is configured to execute the instructions,
after a completion of the machine learning,
to extract a maximum likelihood estimate of the simulation parameter by sampling on an assumption that the simulation parameter is regarded as a variable in the model.

3. The information processing device according to claim 1,
wherein the model is a restricted Boltzmann machine.

4. The information processing device according to claim 1,
wherein the model is a neural network including three or more layers.

5. The information processing device according to claim 4,
wherein the model includes a first neural network configured in a former part of the model and a second neural network configured in a latter part of the model,
wherein the at least one processor is configured to execute the instructions to
perform machine learning of the first neural network based on the observed data and the observation result and
perform a machine learning of the second neural network based on the output from the first neural network and the simulation parameter,
wherein the at least one processor is configured to execute the instructions to perform,
based on a result of the machine learning of the second neural network,
the sampling of the simulation parameter to be used in the machine learning of the second neural network, and
wherein the at least one processor is configured to execute the instructions to perform the machine learning of the second neural network again based on error evaluation on the simulation result obtained by using the sampled simulation parameter.

6. The information processing device according to claim 5,
wherein the first neural network is a network categorized as an auto-encoder.

7. The information processing device according to claim 5,
wherein the first neural network is a deep neural network.

8. The information processing device according to claim 5,
wherein the at least one processor is configured to execute the instructions,
after a completion of the machine learning,
to extract a maximum likelihood estimate of the simulation parameter by sampling on an assumption that the simulation parameter is regarded as a variable in the second neural network.

9. The information processing device according to claim 5,
wherein the at least one processor is further configured to execute the instructions,
after a completion of the machine learning,
to extract an estimate of the simulation parameter by applying a tabu search or a genetic algorithm on an assumption that the simulation parameter is regarded as a variable in the second neural network.

10. The information processing device according to claim 1,
wherein the at least one processor is configured to execute the instructions to determine that the machine learning is completed when an error indicated by the error evaluation is equal to or less than a threshold value.

11. The information processing device according to claim 1,
wherein the machine learning is a machine learning of binary classification based on a label of an inputted simulation parameter,
the label indicating either a positive example or a negative example, and
wherein the at least one processor is configured to execute the instructions
to generate the label based on the error estimation and thereby
to perform the machine learning again based on the sampled simulation parameter.

12. A control method executed by a computer, the control method comprising:
performing a machine learning of a model which represents the relation among observed data, an observation result, and a simulation parameter,
the simulation parameter being required when performing a simulation for predicting the observation result based on observed data;
performing, based on a result of the machine learning, sampling of a simulation parameter to be used for machine learning;
performing a simulation using the sampled simulation parameter; and
performing the machine learning again based on an error evaluation on a simulation result which is a result of the simulation.

13. A non-transitory computer readable storage medium storing a program executed by a computer, the program causing the computer to:
perform a machine learning of a model which represents the relation among observed data, an observation result, and a simulation parameter,
the simulation parameter being required when performing a simulation for predicting the observation result based on observed data;
perform, based on a result of the machine learning, sampling of a simulation parameter to be used for machine learning;
perform a simulation using the sampled simulation parameter; and
perform the machine learning again based on an error evaluation on a simulation result which is a result of the simulation.
